(19) United States
(12) Patent Application Publication
(10) Pub. No.: US 2026/0017573 A1
(43) Pub. Date: Jan. 15, 2026

(54) AUTOMATED TASK DETECTION USING MACHINE LEARNING AND LARGE LANGUAGE MODEL

(71) Applicant: RAPTORXAI PRIVATE LIMITED, Tellapur (IN)

(72) Inventor: Pratyusha Vemuri Venkata, Tellapur (IN)

(21) Appl. No.: 19/253,668

(22) Filed: Jun. 27, 2025

(30) Foreign Application Priority Data
Jul. 10, 2024 (IN) 202441052895

(51) Int. Cl. G06N 20/20

(52) U.S. Cl. CPC G06N 20/20

(57) ABSTRACT

The invention relates to a method for improving task detection through a combination of machine learning and natural language processing. The method involves preparing data by preprocessing and cleaning to ensure suitability for machine learning algorithms, followed by training a LightGBM model using the prepared data. Task detection results are generated using the trained LightGBM model. The method further includes analyzing feature importance and generating new features using a large language model (LLM). These new features are used to expand the dataset, and the LightGBM model is retrained to enhance task detection performance. This approach automates feature extraction, improves performance, increases adaptability, and enhances the generalizability of task detection methods.

### FIELD OF THE INVENTION

The invention pertains to the field of machine learning and data processing. Specifically, the invention relates to advanced task detection systems designed to provide enhanced accuracy, generalizability, and cost-effectiveness through automated feature extraction and generation using a combination of LightGBM models and large language models (LLMs).

### BACKGROUND OF THE INVENTION

Traditional task detection methods have long been hindered by their reliance on manually extracted features. This process is not only time-consuming and labor-intensive but also susceptible to human error and bias. The effectiveness of manually extracted features is heavily dependent on the expertise of the individuals involved, which can vary widely and lead to inconsistent results. Furthermore, manual feature extraction often fails to capture the complex, non-linear patterns inherent in large and diverse datasets, resulting in suboptimal performance for complex tasks.

One of the significant drawbacks of traditional task detection approaches is their reliance on a fixed set of features. This rigidity poses a substantial challenge as it limits the models' ability to adapt to new tasks or changing data distributions. In dynamic environments where data characteristics evolve, these fixed feature sets quickly become outdated, leading to a degradation in model performance. The inability to incorporate new, relevant features into the model hampers its generalizability and effectiveness across different domains.

The static nature of traditional feature sets also makes it difficult for these methods to generalize to new domains. When confronted with data from a domain different from the one the model was trained on, traditional task detection methods often struggle to maintain their accuracy and reliability. This lack of adaptability is a critical limitation in fields that require robust performance across various data environments, such as natural language processing, image recognition, and predictive analytics.

Additionally, the cost associated with manual feature engineering is significant. The need for domain experts to meticulously extract and curate features increases the time and financial investment required to develop effective task detection models. This high cost can be prohibitive, especially for smaller organizations or projects with limited resources. Consequently, many potential applications of task detection remain unexplored or underdeveloped due to these financial constraints.

Another issue with traditional task detection methods is their often subpar accuracy. Manual feature extraction, while sometimes effective, cannot consistently uncover all the intricate patterns present in complex datasets. This limitation results in models that may perform adequately in controlled settings but fail to achieve high accuracy in real-world applications. The gap between model performance in development versus deployment environments is a persistent challenge in the field.

Moreover, traditional methods are not equipped to handle the increasing volume and variety of data generated in today's digital landscape. As data grows in size and complexity, manual feature extraction becomes increasingly impractical. The sheer scale of modern datasets necessitates automated methods capable of efficiently processing and extracting meaningful features without human intervention. Traditional approaches are ill-suited to meet this demand, leading to bottlenecks in data processing and analysis.

In addition, traditional task detection methods often lack the ability to identify and leverage high-level abstractions within the data. Manually extracted features tend to be low-level and may miss the broader, more abstract patterns that could significantly enhance model performance. This limitation prevents models from achieving their full potential and reduces their applicability in complex scenarios where higher-level insights are crucial.

Finally, the iterative improvement of task detection models is challenging with traditional methods. The process of refining features and retraining models is cumbersome and slow, often requiring extensive manual effort for each iteration. This inefficiency slows down the pace of development and innovation in the field, preventing rapid adaptation to new data and emerging trends. Traditional methods are thus not well-suited to the agile, iterative processes needed for continuous improvement in task detection.

### SUMMARY OF THE INVENTION

To address the foregoing problems, in whole or in part, and/or other problems that may have been observed by persons skilled in the art, the present disclosure provides compositions and methods as described by way of example as set forth below.

The principal object of the present invention is to enhance the accuracy and effectiveness of task detection by utilizing machine learning algorithms that can automatically learn and extract the most relevant and informative features from the data, leading to significantly improved performance.

Another object of the invention is to minimize the time and effort required for feature engineering by automating the feature extraction process, thus eliminating the need for manual intervention and expediting the overall task detection process.

Another object of the invention is to ensure the system's adaptability to new tasks or changing data distributions by enabling the easy retraining of machine learning models, thereby maintaining high performance in diverse and evolving environments.

Another object of the invention is to improve the generalizability of task detection methods by employing a machine learning approach that can effectively adapt to various tasks and data distributions, focusing on the most impactful features for decision making.

In view of the foregoing, the present invention provides an method for improving task detection comprising preparing data by preprocessing and cleaning to ensure suitability for machine learning algorithms, training a LightGBM model using the prepared data, generating task detection results using the trained LightGBM model, analyzing feature importance and generating new features using a large language model (LLM), and expanding the dataset with the new features and retraining the LightGBM model to improve task detection performance.

In another aspect of the present invention, the data preparation includes dividing the data into training, validation, and testing sets.

In another aspect of the present invention, the preprocessing and cleaning of data includes removing noise, handling missing values, and normalizing data.

In another aspect of the present invention, the training of the LightGBM model includes optimizing model hyperparameters using the validation set.

In another aspect of the present invention, the method comprising generating task detection results includes evaluating model performance using metrics such as accuracy, precision, and recall.

In another aspect of the present invention, the metrics to evaluate the model performance include F1 score, area under the receiver operating characteristic (ROC) curve, and mean squared error (MSE).

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a flowchart of framework for fraud detection in financial transactions, in accordance with an embodiment of the present invention;

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present invention introduces an advanced method for task detection that leverages the combined power of machine learning and natural language processing to enhance accuracy, adaptability, and efficiency. The core of the invention lies in automating the feature extraction process using a LightGBM model and a large language model (LLM). This method begins with data preparation, which includes preprocessing and cleaning to ensure the data is suitable for machine learning algorithms. The cleaned data is then used to train a LightGBM model, a decision tree-based algorithm known for its efficiency and performance.

Once the initial LightGBM model is trained, it generates task detection results, which provide a baseline performance measure. To further improve the model, the invention employs an LLM to analyze feature importance and generate new, complex features that traditional methods might overlook. These new features are then incorporated into the existing dataset, expanding it with richer and more informative data. This step is crucial as it allows the model to capture more nuanced patterns and relationships within the data.

Subsequently, the expanded dataset is used to retrain the LightGBM model. This retraining process enhances the model's ability to detect tasks more accurately by utilizing the newly generated features. The iterative nature of this method ensures continuous improvement, as the model is consistently updated with new features and re-evaluated for performance gains. This iterative cycle of feature generation, dataset expansion, and model retraining enables the system to adapt to new tasks and evolving data distributions seamlessly.

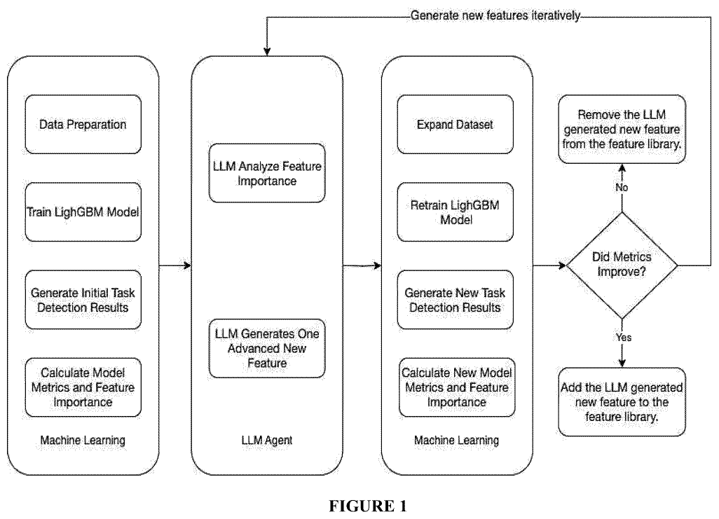

In accordance with an embodiment of the present invention, FIG. 1 illustrates a flowchart of framework for fraud detection in financial transaction. This flowchart delineates a sophisticated iterative methodology for feature extraction and generation in task detection, utilizing the synergistic capabilities of machine learning and large language models (LLM). Initially, a LightGBM model is trained to identify preliminary task detection results and establish baseline performance metrics. The process advances by analyzing feature importance within this model, followed by deploying an LLM to generate new, complex features that enhance the dataset. This enriched dataset is then used to retrain the LightGBM model, aiming to refine its predictive accuracy and overall performance. Post-retraining, the model's performance metrics are rigorously evaluated to assess improvements. This cycle of feature analysis, generation, dataset expansion, and model retraining is repeated iteratively, fostering continuous enhancement until the desired performance metrics are attained. This method not only boosts the accuracy and efficiency of task detection models but also enhances their adaptability and generalizability across diverse and evolving data landscapes.

The process begins with data preparation (A), a critical step to ensure the data's suitability for machine learning algorithms. This involves preprocessing and cleaning the data, which may include tasks such as handling missing values, normalizing data, and removing noise. The cleaned data is then divided into three sets: training, validation, and testing. The training set is used to build the model, the validation set is used for tuning model parameters, and the testing set is reserved for evaluating the model's performance. Proper division and preparation of data are foundational to achieving reliable and accurate machine learning models.

Following data preparation, the LightGBM model is trained (B). This training process involves feeding the training data into the model, allowing it to learn from the data's patterns. During this phase, hyperparameters of the model are optimized using the validation set to enhance the model's performance. Once trained, the LightGBM model is used to generate initial task detection results (C) by applying it to the testing data. These initial results are evaluated using performance metrics such as accuracy, precision, and recall, which provide insights into the model's effectiveness.

The next step is to calculate the model's metrics and feature importance (D). The metrics computed from the testing data serve as a baseline measure of performance, indicating how well the initial model performs. Analyzing feature importance using the trained LightGBM model (E) identifies which features significantly impact task detection. This analysis is crucial as it informs further feature engineering and model improvement efforts. In the subsequent phase, a large language model (LLM) is employed to generate new features (F). The LLM can extract complex patterns and relationships from the data that traditional feature engineering methods might overlook. These newly generated features are incorporated into the existing dataset (G), enriching it with more informative data. The expanded dataset is then used to retrain the LightGBM model (H), which now benefits from the additional features.

The retrained model is applied to the testing data to generate new task detection results (I), which are assessed to compare performance against the original model. Metrics of the retrained model are calculated (J) to determine whether there has been an improvement. If the new metrics indicate significant enhancement (K), the LLM-generated features are added to the feature library (L). If not, those features are removed (M). This iterative process (N) of feature importance analysis, feature generation, dataset expansion, model retraining, and metrics evaluation continues until the optimal set of features is identified, aiming for the highest possible task detection performance. This approach ensures continuous improvement and adaptation to new data and evolving task detection requirements.

### EVALUATION

### ACC, ROC-AUC Score and F1 Score on fraud benchmarks

### Transaction Dataset

Home Credit Default Risk-Can you predict how capable each applicant is of repaying a loan?

### Data Description

| | Train dataset | Validation dataset | Test dataset |
|---|---|---|---|
| Number of data | 184506 | 61502 | 61502 |
| Number of features | 17 | 17 | 17 |

### Benchmark

To isolate the impact of Large Language Model (LLM) generated features, this experiment focused solely on the bureau data, which pertains to all client's previous credits provided by other financial institutions that were reported to the Credit Bureau (for clients who have a loan in the dataset sample).

It is important to note that the initial model's performance metrics may be lower in this scenario compared to a model incorporating additional application information.

The winner of this kaggle benchmark utilizes 8 feature files and reaches 80.05% of ROC-AUC score on the test dataset.

However, this controlled setting allows for a direct comparison of the effectiveness of LLM generated features on the bureau data alone. The comparison focuses solely on the difference in model performance between the baseline model and the model utilizing the LLM generated features.

| Number of | | | | Number of LLM |
|---|---|---|---|---|
| iteration with | | ROC-AUC | F1 Macro | generated |
| rules improver | Accuracy | Score | Score | features |
| Initial ML | 59.88% | 64.74% | 46.52% | 17 |
| Model | | | | |
| 5th | 59.54% | 64.88% | 46.37% | 23 |
| 10^{th} | 59.54% | 64.81% | 46.34% | 28 |
| 15^{th} | 59.84% | 64.98% | 46.56% | 33 |
| 20^{th} | 60.27% | 65.57% | 46.82% | 38 |
| 25^{th} | 60.35% | 65.63% | 46.88% | 43 |

### Some of the Non-Limiting Advantages of the Present Invention Are:

Reduced Manual Effort: Automates the feature extraction process, eliminating the need for manual feature engineering and saving time.
Enhanced Accuracy: Utilizes machine learning algorithms to identify the most relevant features, significantly improving task detection accuracy.
Increased Adaptability: Easily adapts to new tasks and changing data distributions by retraining the machine learning models.
Improved Generalizability: Enhances the generalizability of task detection methods, allowing effective performance across diverse domains.
Cost-Effective: Reduces the cost of feature engineering by automating the process and focusing on impactful features, leading to resource savings.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A method for improving task detection comprising:
preparing data by preprocessing and cleaning to ensure suitability for machine learning algorithms;
training a LightGBM model using the prepared data;
generating task detection results using the trained LightGBM model;
analyzing feature importance and generating new features using a large language model (LLM);
expanding the dataset with the new features and retraining the LightGBM model to improve task detection performance.

2. The method of claim 1, wherein the data preparation includes dividing the data into training, validation, and testing sets.

3. The method of claim 1, wherein the preprocessing and cleaning of data includes removing noise, handling missing values, and normalizing data.

4. The method of claim 2, wherein the training of the LightGBM model includes optimizing model hyperparameters using the validation set.

5. The method of claim 1, wherein generating task detection results includes evaluating model performance using metrics such as accuracy, precision, and recall.

6. The method of claim 5, wherein the metrics to evaluate the model performance include F1 score, area under the receiver operating characteristic (ROC) curve, and mean squared error (MSE).

7. The method of claim 1, wherein analyzing feature importance by the LLM involves techniques such as attention mechanisms or gradient-based methods to rank feature significance.

8. The method of claim 1, wherein the new features generated by the LLM are based on deep learning architectures such as transformers or recurrent neural networks (RNNs).

9. The method of claim 1, wherein expanding the dataset includes augmenting the data with synthetic samples generated by the LLM.

10. The method of claim 1, wherein retraining the LightGBM model includes adjusting the learning rate and tree complexity to accommodate the expanded dataset.

11. The method of claim 1, wherein the iterative process of feature analysis and model improvement includes removing features that negatively impact model performance as identified by the LLM.

12. The method of claim 1, wherein the evaluation of improvement in model metrics involves statistical tests such as paired t-tests or Wilcoxon signed-rank tests to ensure significant performance gains.

13. The method of claim 1, wherein the LLM is fine-tuned on domain-specific data to enhance its feature generation and analysis capabilities.

14. The method of claim 1, wherein the entire process is automated using a pipeline that schedules and executes the steps in sequence without manual intervention.
